(19) United States
(12) Patent Application Publication
(10) Pub. No.: US 2013/0056126 A1
(43) Pub. Date: Mar. 7, 2013

(54) AIRCRAFT TIRE

(71) Applicants: Kiyoshi Ueyoko, Copley, OH (US); Leonard James Reiter, Norton, OH (US); Maure Ellen Knavish, Hartville, OH (US); David Charles Wagner, Wadsworth, OH (US); David Paul George, Akron, OH (US); Bret Herbert Marts, Cuyahoga Falls, OH (US); John Joseph Slivka, Danville, VA (US)

(72) Inventors: Kiyoshi Ueyoko, Copley, OH (US); Leonard James Reiter, Norton, OH (US); Maure Ellen Knavish, Hartville, OH (US); David Charles Wagner, Wadsworth, OH (US); David Paul George, Akron, OH (US); Bret Herbert Marts, Cuyahoga Falls, OH (US); John Joseph Slivka, Danville, VA (US)

(21) Appl. No.: 13/225,799

(22) Filed: Sep. 6, 2011

(51) Int. Cl. B60C 15/06

(52) U.S. Cl. 152/541

(57) ABSTRACT

A pneumatic tire in accordance with the present invention includes two annular bead portions, a carcass, and a belt reinforcement layer. The carcass extends between the bead portions through sidewall portions and a tread portion. The carcass has at least one carcass ply of parallel cords turned up about the bead portions. The belt reinforcement layer is disposed radially outside the carcass and radially inside the tread portion. Each annular bead portion includes an annular bead core having the carcass ply turned up around the bead core, a first apex disposed adjacent and radially outward of the bead core, a second apex disposed axially outward of the bead core and the carcass ply, a first chafer disposed adjacent the carcass ply and axially outward of the bead core, and a second chafer disposed adjacent and axially outward the second apex and axially inward a sidewall portion. The first apex comprises a material with a 100 percent modulus between 1.0 MPa and 6.0 MPa. The second apex comprises a material with a 100 percent modulus between 1.0 MPa and 6.0 MPa. The first chafer comprises a material with a 100 percent modulus between 2.0 MPa and 4.0 MPa. The second chafer comprises a material with a 100 percent modulus between 1.0 MPa and 6.0 MPa. The sidewall portions comprise a material with a 100 percent modulus between 1.0 MPa and 2.0 MPa.

### TECHNICAL FIELD

The present invention relates to a tire with radial carcass reinforcement intended to support heavy loads and inflated to relatively high pressures for high speed use, such as an aircraft tire.

### BACKGROUND OF THE INVENTION

The radial carcass reinforcements of tires generally comprise several plies of textile cords, which are anchored in each bead to at least one bead wire and generally have a single bead wire. The reinforcing elements of these reinforcements are wound around the bead wire from the inside to the outside, forming turn-ups, the respective ends of which are spaced radially from the axis of rotation of the tire. The severe conditions under which aircraft tires operate produces a short life of the beads.

A substantial improvement in performance may be obtained by separating the plies of the carcass reinforcement into two groups. The first group may comprise plies of the carcass reinforcement disposed adjacent the beads. This first group may be wound around a bead wire in each bead from the inside to the outside of the tire. The second group may be formed of at least one axially outer ply in the region of the beads, which ply may be generally wound around the bead wire from the outside to the inside of the tire.

The life of beads formed in this manner may be lengthened by the presence in each bead of an additional reinforcement ply, wound around the bead wire and thus forming an axially outer leg and an axially inner leg. Such a flipper may be the ply closest to the rubber filler, radially above the anchoring bead wire. Life of the beads may be further lengthened by positioning the ends of the turn-ups of the inner carcass plies and the ends of the legs of the flipper, with respect to the radial position of the radially upper end of the rubber filler located above the bead wire and the filler.

A conventional aircraft tire, inflated to a relatively high pressure, may have a tread, a crown reinforcement, and a radial carcass reinforcement comprising: at least two axially inner plies of textile cords wound around a bead wire in each bead from the inside to the outside forming turn-ups; and at least one axially outer ply of textile cords superimposed over the inner plies below the crown reinforcement and along the turn-ups in the beads. The bead wire may be radially surmounted by a filler of a vulcanized rubber mix. The filler may have the cross-section of a triangle, the apex of which extends radially furthest from the axis of rotation of the tire a distance from a straight line parallel to the axis, passing through the geometrical center of the circle circumscribed on the cross-section of the anchoring bead wire, known as a reference line.

The tire may also comprise at least one inner flipper wound around the bead wire to form an axially inner leg and an axially outer leg which may be positioned axially adjacent to the filler and the bead wire. The end of the axially outer leg of the inner flipper may be located at a radial distance from the reference line. The end of the turn-up of the inner carcass ply may be arranged axially furthest to the inside a distance from the reference line and the ends of the inner leg of the inner flipper and the turn-ups of the inner carcass ply or plies, respectively.

While this conventional construction may be durable, the number of carcass plies that may be provided in the bead area and the extended length of the flipper limits the outer plies turned down around the bead and the inner plies spaced from the natural ply path of the tire in the region of the flipper. This spacing may result in one less ply being available in the structure and in the case of a large aircraft tire, ideally may require the use of another ply effectively precluded by the use of the extended length flipper. It is an object of the present invention to provide a lightweight efficient tire structure having enhanced bead durability and mitigated chafing.

### SUMMARY OF THE INVENTION

A pneumatic tire in accordance with the present invention includes two annular bead portions, a carcass, and a belt reinforcement layer. The carcass extends between the bead portions through sidewall portions and a tread portion. The carcass has at least one carcass ply of parallel cords turned up about the bead portions. The belt reinforcement layer is disposed radially outside the carcass and radially inside the tread portion. Each annular bead portion includes an annular bead core having the carcass ply turned up around the bead core, a first apex disposed adjacent and radially outward of the bead core, a second apex disposed axially outward of the bead core and the carcass ply, a first chafer disposed adjacent the carcass ply and axially outward of the bead core, and a second chafer disposed adjacent and axially outward the second apex and axially inward a sidewall portion. The first apex comprises a material with a 100 percent modulus between 1.0 MPa and 6.0 MPa. The second apex comprises a material with a 100 percent modulus between 1.0 MPa and 6.0 MPa. The first chafer comprises a material with a 100 percent modulus between 2.0 MPa and 4.0 MPa. The second chafer comprises a material with a 100 percent modulus between 1.0 MPa and 6.0 MPa. The sidewall portions comprise a material with a 100 percent modulus between 1.0 MPa and 2.0 MPa.

According to another aspect of the present invention, the pneumatic tire further includes a flipper wound around the bead core to form an axially inner leg and an axially outer leg.

According to still another aspect of the present invention, the carcass has at least two plies comprising a radially inner first ply and a radially inner second ply, the second ply being radially outward of the first ply, the turnup ends of the first ply being radially lower than the turnup ends of the second ply.

According to yet another aspect of the present invention, the carcass includes a radially inner first ply, a second ply, a third ply, and a fourth ply, respectively extending outwardly, the turn-up ends of the third ply being radially lower than the turn-up ends of the first ply.

### DEFINITIONS

“100 percent Modulus” means the force in mega-pascals (MPa) required to produce 100 percent elongation (e.g., stretch to two times original length).

“300 percent Modulus” means the force in mega-pascals (MPa) required to produce 300 percent elongation (e.g., stretch to four times original length).

“Apex” means an elastomeric filler located radially above the bead core and between the plies and the turnup ply or axially outside the turnup ply.

“Annular” means formed like a ring.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread (e.g., the whole tire).

“Chafer” refers to a narrow strip of material placed around the exterior of the bead to protect bead structures from the rim, distribute flexing radially above the rim, and to better seal the tire to the rim.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). Dtex means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“Inner” means toward the inside of the tire and “outer” means toward its exterior.

“Innerliner” means the layer or layers of elastomer or other material that form the inside surface of a tubeless tire and that contain the inflating fluid within the tire.

“Lateral” means an axial direction.

“Load Range” means load and inflation limits for a given tire used in a specific type of service as defined by tables in The Tire and Rim Association, Inc.

“Normal Load” means the specific design inflation pressure and load assigned by the appropriate standards organization for the service condition for the tire.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Stiffness ratio” means the value of a control belt structure stiffness divided by the value of another belt structure stiffness when the values are determined by a fixed three point bending test having both ends of the cord supported and flexed by a load centered between the fixed ends.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

### BRIEF DESCRIPTION OF THE DRAWINGS

The present invention will be described by way of example and with reference to the accompanying drawing, in which:

FIG. 1 is an example schematic partial cross-sectional view of a bead structure in accordance with the present invention.

### DETAILED DESCRIPTION OF AN EXAMPLE OF THE PRESENT INVENTION

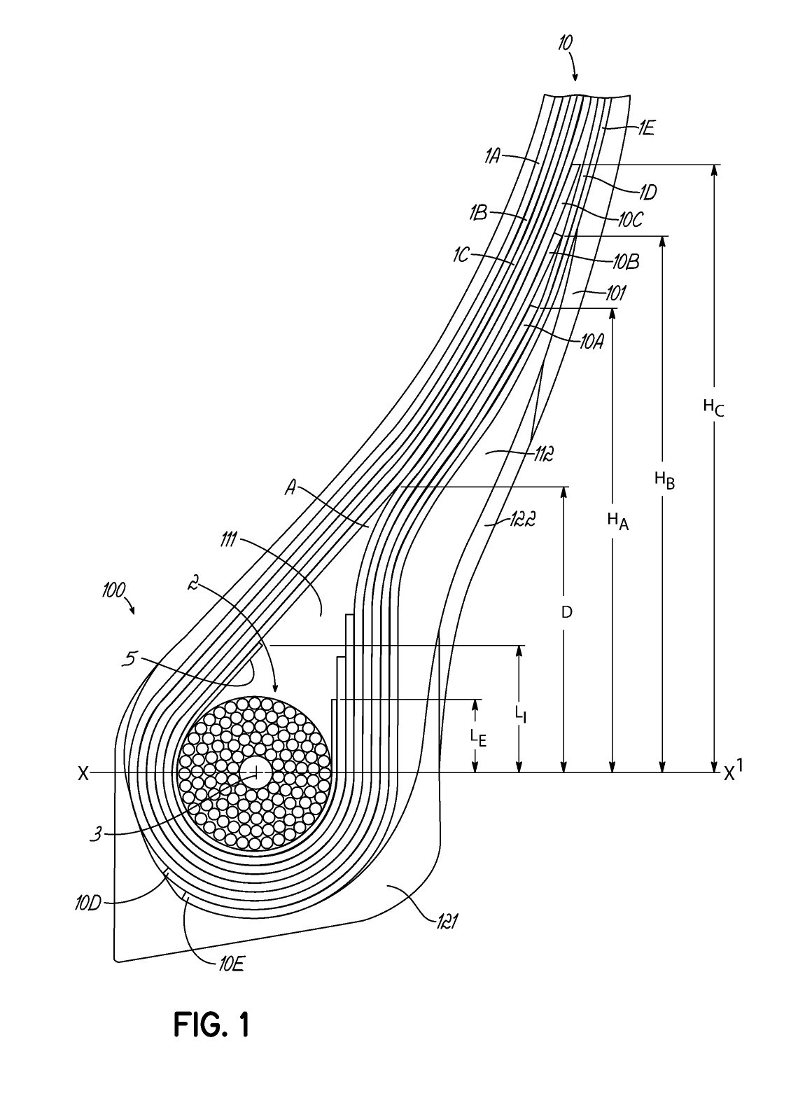

FIG. 1 schematically shows a partial cross section of an example tire bead structure 100 of a pneumatic tire in accordance with the present invention. The example tire shown is that of a standard size tire 50x20R22 with a load rating of 57,100 pounds and a pressure rating of 220 psi. Such a structure 100 may produce excellent durability and reduced chafing at the rim. A carcass reinforcement 10 may be formed of five plies 1A to 1E of radial textile cords. Among these five plies, three axially inner plies 1A, 1B, 1C may be wound in each bead 2 around a circular bead wire 3 extending from the inside to the outside of the tire in order to form turn-ups 10A, 10B, 10C.

The cross section of the bead wire 3 may be radially surmounted by a filler or first apex 111 of elastomeric mix having substantially the shape of a triangle in cross-section, the terminal end A of which extends radially from the axis of rotation of the tire a distance D from a reference line XX¹ extending axially through the center of the bead wire. The turn-up 10A of the inner carcass ply 1A axially furthest towards the inside may have its end spaced radially form the line XX¹ by the amount HA, which, for example, may be 54 mm or 1.5 times the distance D, 36 mm. Further, for example, the ends of the inner plies 10B and 10C may also be located radially above the terminal end A of the first apex 111 at distances HB and HC of 58 mm and 68 mm, respectively.

A flipper 5 may separate the bead wire 3 from the carcass reinforcement 10 and be formed of radial textile cords identical to the carcass ply cords (or different cords). One terminal end of the flipper 5 may, for example, may extend a radial distance LI of 18 mm from the line XX¹, a distance that may be less than the distances HB and HC referred to above. Three ends may thus be arranged radially above the terminal end A of the first apex 111 and be staggered between the terminal end and a location of the sidewall where the tire has a maximum axial width. The other terminal end of the flipper 5 may extend a radial distance LE from the line XX¹ equal to 10 mm.

The two carcass plies 1D, 1E, hereinafter referred to as outer plies, may encase the turn-ups 10A, 10B, 10C of the inner carcass plies 1A, 1B, 1C. The plies 1D and 1E may, for example, be wound around the bead wire 3 over a portion or circular arc corresponding to an angle at the center of the circle circumscribed on the bead wire 3 equal to 180° so that the ends 10D, 10E of these outer plies 1D, 1E are situated radially below the reference line XX¹.

The tire bead 2 may be supplemented by a reinforcement ply or outer first chafer 121 reinforced with radial textile cords. The rubber chafer 121 may permit a better distribution of the pressures between the tire and its service rim, as well as assuring protection of the carcass plies 1A-1E against injury upon mounting. The axially outer end of the first chafer 121 may be slightly above (about 20 mm) the reference line XX¹, while its axially inner end may be below the line XX¹.

An example tire with a bead structure as shown in FIG. 1 may include two annular bead portions/structures 100, a carcass 10 extending between the bead portions through two sidewall portions 101, and a tread portion (not shown). The carcass 10 may have at least one carcass ply 1A, 1B, 1C, 1D, and/or 1E of parallel cords turned up about the bead portions 100, and a belt reinforcement layer (not shown) disposed radially outside the carcass 10 and radially inside the tread portion. Each annular bead portion 100 may include an annular bead core 3 having the carcass ply or plies 1A-1F turned up around the bead core, a first apex 111 disposed adjacent and radially outward of the bead core, a second apex 112 disposed axially outward of the bead core and the carcass ply or plies, a first chafer 121 disposed adjacent the carcass ply or plies and axially outward of the bead core, and a second chafer 122 disposed adjacent and axially outward of the second apex.

The first apex 111 may be constructed of a material with a 100 percent modulus between 1.0 MPa and 6.0 MPa. The second apex may be constructed of a material with a 100 percent modulus between 1.0 MPa and 6.0 MPa. The first chafer 121 may be constructed of a material with a 100 percent modulus between 2.0 MPa and 4.0 MPa. The second chafer 122 may be constructed of a material with a 100 percent modulus between 1.0 MPa and 6.0 MPa. The axially outer end of the second chafer 122 may be about 60 mm above the line XX¹. The axially outer end of the second chafer 122 may thus cover the contact area between the tire and the wheel flange under a 200% rated loading condition. The sidewall portion 101 may be constructed of a material with a 100 percent modulus between 1.0 MPa and 2.0 MPa.

Below is a Table of other example properties for the first apex 111, second apex 112, first chafer 121, second chafer 122, and sidewall portion 101.

TABLE 1

| | Chafer 1 | Chafer 2 | Apex 1 | Apex 2 | Side wall |
|---|---|---|---|---|---|
| 100% modulus (MPa) | 2.5 | 2 | 4.1 | 2.2 | 1.1 |
| 300% modulus (MPa) | 7.4 | 10 | 17.6 | 11 | 5.95 |
| Tensile strength (MPa) | 13.4 | 15.4 | 21.5 | 28.9 | 15.47 |
| Elongation at break (%) | 520 | 440 | 400 | 570 | 619 |
| 100° C. hardness | 68.6 | 62.6 | 77.2 | 57.2 | 50.2 |
| 100° C. rebound (%) | 38.2 | 56.8 | 58.3 | 73.1 | 58 |
| G′ (1%, 100° C., 1 Hz) (MPa) | 5.71 | 3.37 | 6.82 | 1.7686 | 1.2923 |
| G′ (10%, 100° C., 1 Hz) (MPa) | 2.34 | 2.06 | 3.56 | 1.3932 | 0.9488 |
| G′ (50%, 100° C., 1 Hz) (MPa) | 1.08 | 1.29 | 2 | 1.0657 | 0.7042 |
| TD (10%, 100° C., 1 Hz) | 0.29 | 0.13 | 0.15 | 0.056 | 0.12 |

As stated above, a bead structure 100 in accordance with the present invention produces excellent durability and reduced chafing at the rim. This bead structure 100 thus enhances the performance of the pneumatic tire, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, Pages 207 and 208 (1981). An important structural element is the bead structure, typically made up of many flexible, high modulus cords of natural textile, synthetic polymer, glass fiber, or fine hard drawn steel embedded in, and bonded to, a matrix of low modulus polymeric materials, usually natural or synthetic rubber. Id. at 207 and 208.

The flexible, high modulus cords are usually disposed as a single layer. Id. at 208. Tire manufacturers throughout the industry cannot agree or predict the effect of different twists of cords on noise characteristics, handling, durability, comfort, etc. in pneumatic tires, Mechanics of Pneumatic Tires, Pages 80 through 85.

These complexities are demonstrated by the below table of the interrelationships between tire performance and tire components.

| | | CARCASS | APEX/ | | | | |
|---|---|---|---|---|---|---|---|
| | LINER | PLY | BEAD | BELT | OV'LY | TREAD | MOLD |
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE | X | X | X | | | X | |
| COMFORT | | | | | | | |
| HIGH SPEED | | X | X | X | X | X | X |
| AIR | X | | | | | | |
| RETENTION | | | | | | | |
| MASS | X | X | X | X | X | X | X |

As seen in the table, apex/bead characteristics affect the other components of a pneumatic tire (e.g., apex/bead affects belt, tread, mold, etc.), leading to a number of components interrelating and interacting in such a way as to affect a group of functional properties (noise, handling, durability, rolling resistance, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (e.g., number of apexes, number of chafers, etc.) of the bead of a pneumatic tire is modified with the intent to improve one functional property of the pneumatic tire, any number of other functional properties may be unacceptably degraded. Furthermore, the interaction between the bead and the apex, belt, carcass, and tread may also unacceptably affect the functional properties of the pneumatic tire. A modification of the bead may not even improve that one functional property because of these complex interrelationships.

Thus, as stated above, the complexity of the interrelationships of the multiple components makes the actual result of modification of an apex/bead, in accordance with the present invention, impossible to predict or foresee from the infinite possible results. Only through extensive experimentation have the bead structure 100 of the present invention been revealed as an excellent, unexpected, and unpredictable option for a pneumatic tire.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

1. A pneumatic tire comprising:
two annular bead portions;
a carcass extending between the bead portions through sidewall portions and a tread portion, the carcass has at least one carcass ply of parallel cords turned up about the bead portions; and
a belt reinforcement layer disposed radially outside the carcass and radially inside the tread portion,
each annular bead portion comprising an annular bead core having the carcass ply turned up around the bead core, a first apex disposed adjacent and radially outward of the bead core, a second apex disposed axially outward of the bead core and the carcass ply, a first chafer disposed adjacent the carcass ply and axially outward of the bead core, a second chafer disposed adjacent and axially outward the second apex and axially inward of a sidewall portion, and a flipper wound around the bead core to form an axially inner leg and an axially outer leg, the flipper separating the bead core from the parallel cords of the carcass ply, the flipper being formed of radial textile cords identical to the parallel cords of the carcass ply,
the first apex comprising a material with a 100 percent modulus between 1.0 MPa and 6.0 MPa,
the second apex comprising a material with a 100 percent modulus between 1.0 MPa and 6.0 MPa,
the first chafer comprising a material with a 100 percent modulus between 2.0 MPa and 4.0 MPa,
the second chafer comprising a material with a 100 percent modulus between 1.0 MPa and 6.0 MPa,
the sidewall portion comprising a material with a 100 percent modulus between 1.0 MPa and 2.0 MPa.

2. (canceled)

3. The pneumatic tire as set forth in claim 1 wherein the carcass has at least two plies comprising a radially inner first ply and a radially inner second ply, the second ply being radially outward of the first ply, the turnup end of the first ply being radially lower than the turnup end of the second ply.

4. (canceled)
